(19) United States
(12) Patent Application Publication
(10) Pub. No.: US 2025/0303919 A1
(43) Pub. Date: Oct. 2, 2025

(54) BATTERY CONTROL SYSTEM, BATTERY PACK, ELECTRIC VEHICLE, BATTERY CONTROL METHOD, AND NON-TRANSITORY COMPUTER-READABLE MEDIUM INCLUDING COMPUTER PROGRAM

(71) Applicant: YAMAHA HATSUDOKI KABUSHIKI KAISHA, Iwata-shi (JP)

(72) Inventors: Yoshiyuki RYOGOKU, Shizuoka (JP); Kazuya MATSUBARA, Shizuoka (JP); Takeaki SAKUMOTO, Shizuoka (JP); Satoshi KATAYAMA, Shizuoka (JP); Hirokazu ISOBE, Shizuoka (JP)

(21) Appl. No.: 19/087,746

(22) Filed: Mar. 24, 2025

(30) Foreign Application Priority Data
Mar. 27, 2024 (JP) 2024-051172

(51) Int. Cl. B60L 58/12; B60L 58/16; B62J 43/13; B62J 43/20; H01M 10/42; H01M 10/48

(52) U.S. Cl. CPC B60L 58/12; B60L 58/16; B62J 43/13; H01M 10/425; H01M 10/482; H01M 10/486; B60L 2200/12; B60L 2240/545; B60L 2240/547; B60L 2240/549; B62J 43/20; H01M 2010/4271; H01M 2010/4278; H01M 2220/20

(57) ABSTRACT

A battery control system for an electric vehicle includes a plurality of battery packs each including an authorized battery pack having authority to output electric power to drive an electric motor to generate drive power for the electric vehicle, and an unauthorized battery pack not having the authority. A plurality of controllers of the plurality of battery packs are configured or programmed to mutually transmit/receive internal information on states of the respective battery packs. At least one of the plurality of controllers is configured or programmed to change the authorized battery pack to another battery pack among the plurality of battery packs based on the internal information.

### CROSS REFERENCE TO RELATED APPLICATIONS

This application claims the benefit of priority to Japanese Patent Application No. 2024-051172 filed on Mar. 27, 2024. The entire contents of this application are hereby incorporated herein by reference.

### BACKGROUND OF THE INVENTION

### 1. Field of the Invention

The present invention relates to battery control systems, battery packs, electric vehicles, battery control methods, and non-transitory computer readable media including computer programs.

### 2. Description of the Related Art

Electrically assisted bicycles, by which power of riders performing pedaling is assisted by electric motors, are known as one type of LEVs (Light Electric Vehicles) running by an electric motor as a driving source (see, for example, Japanese Laid-Open Patent Publication No. 2007-230411).

Such an electric motor is supplied with electric power from a battery pack mounted on a vehicle body, and thus generates drive power. Such an electrically assisted bicycle causes the electric motor to generate drive power corresponding to the power of a human body, specifically, the power provided by a user to pedals, and thus alleviates the load imposed on the user while, for example, running on a slope or running with cargo.

There are cases where a plurality of battery packs are mounted on an electrically assisted bicycle in order to increase the distance by which the electrically assisted bicycle can travel while being provided with assist power generated by the electric motor. In such cases, a vehicle controller (e.g., an MCU (motor control unit)) controlling the running of the electrically assisted bicycle manages the plurality of battery packs. The vehicle controller monitors the state of each of the plurality of battery packs, and performs a control of, for example, switching the battery pack supplying the electric power to the electric motor. Therefore, the electrically assisted bicycle having such a plurality of battery packs mounted thereon has a problem that the communication load and the computation load on the vehicle controller are increased.

### SUMMARY OF THE INVENTION

It is desired that the communication load and the computation load on the vehicle controller should be decreased.

This specification discloses battery control systems, battery packs, electric vehicles, battery control methods, and non-transitory computer readable media including computer programs as described below.

According to an example embodiment of the present invention, a battery control system for an electric vehicle includes a plurality of battery packs, the plurality of battery packs each include a battery module including a plurality of battery cells, a controller configured or programmed to control discharge of the battery module and output internal information on a state of the battery pack including the controller therein, and a battery housing to accommodate the battery module and the controller, the plurality of battery packs include an authorized battery pack having authority to output electric power to drive an electric motor that generates drive power for the electric vehicle, and an unauthorized battery pack not having the authority, the controllers of the plurality of battery packs are configured or programmed to mutually transmit/receive the internal information, and at least one of the plurality of controllers is configured or programmed to change the authorized battery pack to another battery pack among the plurality of battery packs based on the internal information.

According to an example embodiment of the present invention, the internal information is mutually transmitted/received between the plurality of battery packs, and the authorized battery pack is changed to another battery pack based on the internal information. A vehicle controller for the vehicle does not need to monitor the states of the plurality of battery packs to perform the process of changing the authorized battery pack. As a result, the communication load and the computation load on the vehicle controller may be alleviated.

In the battery control system above, the internal information includes at least one of life information by which it is checked whether or not the battery pack is operating, information representing presence/absence of abnormality, information representing presence/absence of the authority, information representing an upper limit of a current that can be output, information representing a battery remaining capacity, or information representing a battery capacity.

With this configuration, the plurality of battery packs may monitor each other regarding the states thereof.

In the battery control system above, the plurality of battery packs include a first battery pack as the authorized battery pack, and a second battery pack as the unauthorized battery pack, in a case it is determined that the first battery pack is in a predetermined state, the controller of the first battery pack is configured or programmed to output, to the second battery pack, an instruction indicating that the authority is to be transferred to the second battery pack, and the controller of the second battery pack is configured or programmed to set the second battery pack as the authorized battery pack.

In a case where the first battery pack is in the predetermined state (e.g., a state where the upper limit of the current that can be output is lower than the threshold value), the authority is transferred from the first battery pack to the second battery pack. In this manner, a stable supply of the electric power to the vehicle may be continued.

In the battery control system above, the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

In a case where the first battery pack is in the above-described state, the authority is transferred from the first battery pack to the second battery pack. In this manner, a stable supply of the electric power to the vehicle may be continued.

In the battery control system above, the plurality of battery packs include an authorized battery pack and two or more of the unauthorized battery packs, the controller of the authorized battery pack, in a case it is determined that the authorized battery pack is in a predetermined state, is configured or programmed to determine a transferee battery pack to which the authority is to be transferred from among the two or more unauthorized battery packs, and output, to the transferee battery pack an instruction indicating that the authority is to be transferred to the transferee battery pack, and the controller of the transferee battery pack is configured or programmed to set the transferee battery pack as the authorized battery pack.

In a case where the authorized battery pack is in the predetermined state (e.g., the state where the upper limit of the current that can be output is lower than the threshold value), the authority is transferred to another battery pack. In this manner, a stable supply of the electric power to the vehicle may be continued.

In the battery control system above, the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

In a case where the authorized battery pack is in the above-described state, the authority is transferred to another battery pack. In this manner, a stable supply of the electric power to the vehicle may be continued.

In the battery control system above, the controller of the authorized battery pack, before the authority is transferred, is configured or programmed to determine the transferee battery pack from among the two or more unauthorized battery packs based on the internal information on each of the two or more unauthorized battery packs.

With this configuration, the authority may be transferred to an appropriate battery pack.

In the battery control system above, the controller of the authorized battery pack, before the authority is transferred, is configured or programmed to determine, as the transferee battery pack, a battery pack having the largest battery remaining capacity or the highest upper limit of the current that can be output from among the two or more unauthorized battery packs.

With this configuration, the authority may be transferred to the battery pack that can supply the electric motor with larger electric power.

In the battery control system above, the controller of the authorized battery pack, before the authority is transferred, is configured or programmed to determine the transferee battery pack from among the two or more unauthorized battery packs based on unique information assigned to each of the two or more unauthorized battery packs.

With this configuration, the transferee battery pack may be determined by a simple process.

In the battery control system above, the internal information includes the life information, the plurality of battery packs include a first battery pack as the authorized battery pack and a second battery pack as the unauthorized battery pack, and in a case where it is impossible to receive the life information from the first battery pack, the controller of the second battery pack is configured or programmed to set the second battery pack as the authorized battery pack.

In a case where the authorized first battery pack is not operating, the second battery pack is set as the authorized battery pack. In this manner, a stable supply of the electric power to the vehicle may be continued.

In the battery control system above, the internal information includes the life information, the plurality of battery packs include the authorized battery pack and two or more of the unauthorized battery packs, at least one of the controllers of the two or more unauthorized battery packs, in a case where it is impossible to receive the life information from the authorized battery pack, is configured or programmed to determine a target battery pack to which the authority is to be given from among the two or more unauthorized battery packs, and the controller of the target battery pack is configured or programmed to set the target battery pack as the authorized battery pack.

In a case where the authorized first battery pack is not operating, another battery pack is set as the authorized battery pack. In this manner, a stable supply of the electric power to the vehicle may be continued.

In the battery control system above, at least one of the controllers of the two or more unauthorized battery packs is configured or programmed to determine the target battery pack, from among the two or more unauthorized battery packs, based on the internal information on each of the two or more unauthorized battery packs.

With this configuration, the authority may be transferred to an appropriate battery pack.

In the battery control system above, at least one of the controllers of the two or more unauthorized battery packs is configured or programmed to determine, as the target battery pack, a battery pack having the largest battery remaining capacity or the highest upper limit of the current that can be output from among the two or more unauthorized battery packs.

With this configuration, the authority may be transferred to the battery pack that can supply the electric motor with larger electric power.

In the battery control system above, at least one of the controllers of the two or more unauthorized battery packs is configured or programmed to determine the target battery pack, from among the two or more unauthorized battery packs, based on unique information assigned to each of the two or more unauthorized battery packs.

With this configuration, the target battery pack to which the authority is to be given may be determined by a simple process.

In the battery control system above, the internal information mutually transmitted/received between the plurality of battery packs includes a same type of information on the plurality of battery packs.

With this configuration, the plurality of battery packs may monitor each other regarding the states thereof with no master-slave relationship.

In the battery control system above, the plurality of battery packs are attachable to, and detachable from, the electric vehicle.

With this configuration, the battery packs may each be charged in a state of being detached from the vehicle. In addition, the number of the battery packs to be mounted on the vehicle may be adjusted.

According to an example embodiment of the present invention, an electric vehicle may include the battery control system described above.

With this configuration, the electric vehicle, in which the communication load and the computation load on the vehicle controller is decreased, may be achieved.

In the electric vehicle above, the electric vehicle may be an electrically assisted bicycle.

With this configuration, the electrically assisted bicycle, in which the communication load and the computation load on the vehicle controller (MCU), is decreased may be achieved.

According to an example embodiment of the present invention, a battery control method for controlling a plurality of battery packs for an electric vehicle is executed by a plurality of computers, the plurality of battery packs including an authorized battery pack authorized to output electric power to drive an electric motor that generates drive power for the electric vehicle, and an unauthorized battery pack not having the authority, the plurality of battery packs each configured to output internal information on a state of the corresponding battery pack, the battery control method including mutually transmitting/receiving the internal information between the plurality of battery packs, and changing the authorized battery pack to another battery pack among the plurality of battery packs based on the internal information mutually transmitted/received between the plurality of battery packs.

According to an example embodiment of the present invention, the internal information is mutually transmitted/received between the plurality of battery packs, and the authorized battery pack is changed to another battery pack based on the internal information. A vehicle controller for the vehicle does not need to monitor the states of the plurality of battery packs to perform the process of changing the authorized battery pack. As a result, the communication load and the computation load on the vehicle controller may be alleviated.

According to an example embodiment of the present invention, a non-transitory computer readable medium includes a computer program to cause a plurality of computers to execute a process of controlling a plurality of battery packs for an electric vehicle, the plurality of battery packs including an authorized battery pack authorized to output electric power to drive an electric motor that generates drive power for the electric vehicle, and an unauthorized battery pack not having the authority, the plurality of battery packs each configured to output internal information on a state of the corresponding battery pack, the computer program causing the plurality of computers to mutually transmit/receive the internal information between the plurality of battery packs, and change the authorized battery pack to another battery pack among the plurality of battery packs based on the internal information mutually transmitted/received between the plurality of battery packs.

According to an example embodiment of the present invention, the internal information is mutually transmitted/received between the plurality of battery packs, and the authorized battery pack is changed to another battery pack based on the internal information. A vehicle controller configured or programmed to control the vehicle does not need to monitor the states of the plurality of battery packs to perform the process of changing the authorized battery pack. As a result, the communication load and the computation load on the vehicle controller may be alleviated.

According to an example embodiment of the present invention, a battery pack for an electric vehicle includes a battery module including a plurality of battery cells, a controller configured or programmed to control discharge of the battery module, and a battery housing to accommodate the battery module and the controller, wherein the electric vehicle includes a plurality of battery packs, including the battery pack, mounted thereon, the plurality of battery packs are each configured to output internal information on a state of the corresponding battery pack, the plurality of battery packs include an authorized battery pack having authority to output electric power to drive an electric motor that generates drive power for the electric vehicle, and an unauthorized battery pack not having the authority, the plurality of battery packs are configured to mutually transmit/receive the internal information, and the controller is configured or programmed to change the authorized battery pack to another battery pack among the plurality of battery packs based on the internal information mutually transmitted/received between the plurality of battery packs.

According to an example embodiment of the present invention, the internal information is mutually transmitted/received between the plurality of battery packs, and the authorized battery pack is changed to another battery pack based on the internal information. A vehicle controller for the vehicle does not need to monitor the states of the plurality of battery packs to perform the process of changing the authorized battery pack. As a result, the communication load and the computation load on the vehicle controller may be alleviated.

It is desired that the communication load and the computation load on a vehicle controller for the vehicle should be decreased. According to an example embodiment of the present invention, the internal information is mutually transmitted/received between the plurality of battery packs, and the authorized battery pack authorized to output electric power to drive the electric motor is changed to another battery pack based on the internal information. The vehicle controller for the vehicle does not need to monitor the states of the plurality of battery packs to perform the process of changing the authorized battery pack. As a result, the communication load and the computation load on the vehicle controller may be alleviated.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view showing an electrically assisted bicycle 1 according to an example embodiment of the present invention.

FIG. 2 is a block diagram showing an example of a hardware configuration of a battery pack 21 according to an example embodiment of the present invention.

FIG. 3 shows how a battery pack 21a is attached to, or detached from, the electrically assisted bicycle 1 according to an example embodiment of the present invention.

FIG. 4 is a block diagram showing an example of a hardware configuration of a drive unit 30 according to an example embodiment of the present invention.

FIG. 5 is a block diagram showing a battery control system 20 according to an example embodiment of the present invention.

FIG. 6 is a flowchart showing an example of a process of changing the battery pack 21 having authority according to an example embodiment of the present invention.

FIG. 7 is a flowchart showing another example of a process of changing the battery pack 21 having authority according to an example embodiment of the present invention.

FIG. 8 is a block diagram showing another example of the battery control system 20 according to an example embodiment of the present invention.

FIG. 9 is a flowchart showing still another example of a process of changing the battery pack 21 having authority according to an example embodiment of the present invention.

FIG. 10 is a flowchart showing still another example of a process of changing the battery pack 21 having authority according to an example embodiment of the present invention.

### DETAILED DESCRIPTION OF THE EXAMPLE EMBODIMENTS

Hereinafter, example embodiments of the present invention will be described with reference to the drawings. In the description of the example embodiments, like elements will bear like reference signs, and overlapping descriptions will be omitted. In the drawings, letters F, Re, U and D respectively indicate front, rear, up and down.

In the following example embodiments, an electrically assisted bicycle will be described as an example of LEVs (Light Electric Vehicles), but light electric vehicles according to example embodiments of the present invention are not limited to electrically assisted bicycles. The “LEV (Light Electric Vehicle)” encompasses a personal mobility device. The light electric vehicle may be, for example, an electric bicycle, an electric tricycle, an electric wheelchair, an electrically assisted wheelchair, a PLEV (Personal Light Electric Vehicle) or the like. The “electric bicycle” encompasses a parallel two-wheel vehicle. The “electric wheelchair” encompasses a handle-type electric wheelchair. The electrically assisted bicycle with two wheels will be described below as an example of light electric vehicles, but the light electric vehicle according to example embodiments of the present invention may be an electrically assisted vehicle with three wheels. The following example embodiments are merely illustrative, and do not limit the present invention in any way.

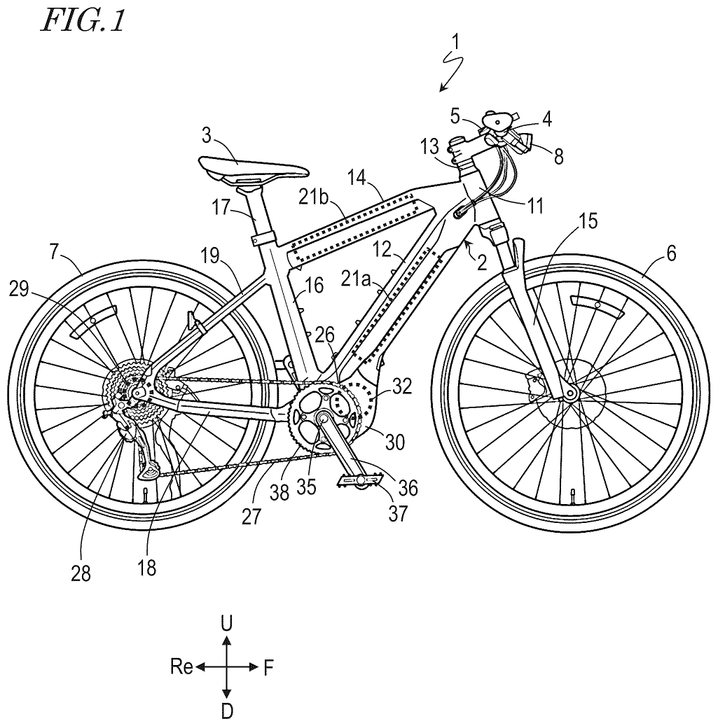

FIG. 1 is a right side view of an electrically assisted bicycle 1 according to an example embodiment of the present invention.

The electrically assisted bicycle 1 includes a body frame 2 extending in a front-rear direction. The body frame 2 includes a head pipe 11, a down tube 12, a top tube 14, a seat tube 16, a chain stay 18, a seat stay 19, and a bracket 26. The head pipe 11 is located at a front end of the body frame 2. A handle column 13 is rotatably inserted into the head pipe 11. A handle 4 is secured to the handle column 13. A meter unit 5 displaying various types of information on the electrically assisted bicycle 1 is provided on the handle 4. A head lamp 8 is provided at the front of the handle 4.

A front fork 15 is secured to a bottom end of the handle column 13. A bottom end of the front fork 15 supports a front wheel 6, which is a steering wheel, such that the front wheel 6 is rotatable.

The down tube 12 extends obliquely rearward and downward from the head pipe 11. The seat tube 16 extends upward from a rear end of the down tube 12. The chain stay 18 extends rearward from a bottom end of the seat tube 16. The bracket 26 connects the rear end of the down tube 12, the bottom end of the seat tube 16 and a front end of the chain stay 18 to each other. The top tube 14 connects a top portion of the head pipe 11 and a top portion of the seat tube 16 to each other. A seat post 17 is inserted into the seat tube 16. The saddle 3, on which the user may sit, is provided at a top end of the seat post 17.

A rear end of the chain stay 18 supports a rear wheel 7, which is a driving wheel, such that the rear wheel 7 is rotatable. The seat stay 19 extends obliquely rearward and downward from the top portion of the seat tube 16. A bottom end of the seat stay 19 is connected with the rear end of the chain stay 18. A transmission 28 to change the transmission ratio is provided at the rear end of the chain stay 18. The transmission 28 may be provided in the vicinity of a pedal crankshaft 35. A speed sensor 29, which detects the rotation rate of the rear wheel 7, is provided on a rear portion of the chain stay 18. The speed sensor 29 may be provided on a bottom portion of the front fork 15 to detect the rotation rate of the front wheel 6.

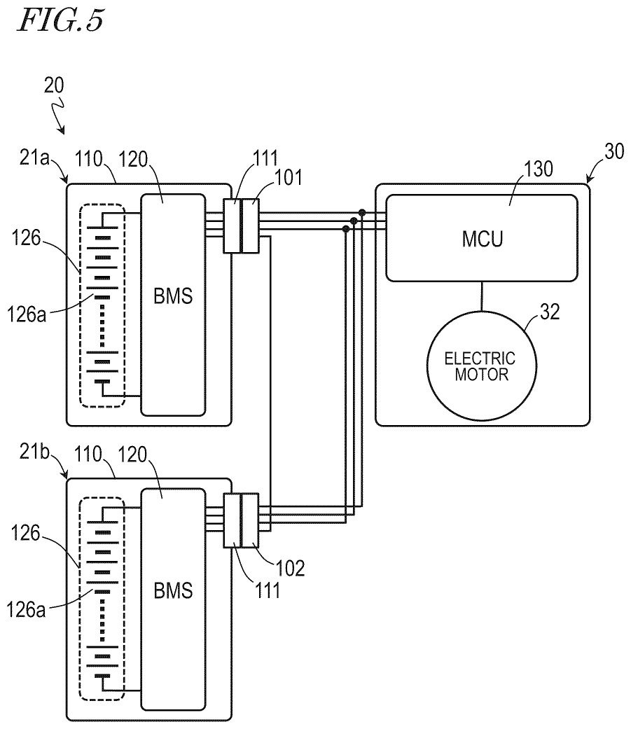

A drive unit 30 is provided on the bracket 26 located in the vicinity of a position, in the body frame 2, that is the center of the vehicle (i.e., the electrically assisted bicycle 1). A housing of the drive unit 30 accommodates an electric motor 32, an MCU (motor control unit) 130 (see FIG. 5), a decelerator, and the like. The pedal crankshaft 35 is supported by the drive unit 30 while running through the drive unit 30 in a left-right direction. Crankarms 36 are respectively provided at both of two ends of the pedal crankshaft 35. Pedals 37 are rotatably provided respectively at tips of the crankarms 36.

The electrically assisted bicycle 1 according to an example embodiment includes a plurality of battery packs 21 mounted thereon. In the example shown in FIG. 1, battery packs 21a and 21b are mounted on the electrically assisted bicycle 1 as the battery packs 21. For example, the battery pack 21a is mounted on the down tube 21 while the battery pack 21b is mounted on the top tube 14. In the example shown in FIG. 1, the battery pack 21a is provided inside the down tube 12, and the battery pack 21b is provided inside the top tube 14. The down tube 12 and the top tube 14 may each be hollow. At least a portion of each of the down tube 12 and the top tube 14 may have a U-shaped cross-section, and the down tube 12 and the top tube 14 may each be provided with a cover covering the U-shaped portion.

The battery pack 21a may be located on an outer surface of the down tube 12. The battery pack 21b may be located on an outer surface of the top tube 14. At least one of the battery packs 21a and 21b may be mounted on the bracket 26 or the seat tube 16. The battery packs 21a and 21b may be attachable to, and detachable from, the electrically assisted bicycle 1.

The battery packs 21a and 21b each include a plurality of battery cells and a BMS (battery management system) 120 (see FIG. 5). The plurality of battery cells are rechargeable batteries. The BMS 120 controls charge/discharge of the corresponding battery pack 21a or 21b, and monitors a state of the corresponding battery pack 21a or 21b.

The electrically assisted bicycle 1 may include three or more battery packs mounted thereon.

The MCU 130 of the drive unit 30 controls operations of the electric motor 32, and also controls operations of various components of the electrically assisted bicycle 1. The MCU 130 includes a semiconductor integrated circuit such as a processor or the like and a motor driving circuit. A rotation of the pedal crankshaft 35 generated by the user stepping on the pedals 37 is conveyed to the rear wheel 7 via a driving sprocket 38 and a chain 27. The MCU 130 controls the electric motor 32 to generate a driving assisting output corresponding to the rotation output of the pedal crankshaft 35 generated by the user stepping on the pedals 37. Assist power generated by the electric motor 32 is conveyed to the rear wheel 7 via the driving sprocket 38 and the chain 27. Instead of the chain 27, a belt, a shaft or the like may be used.

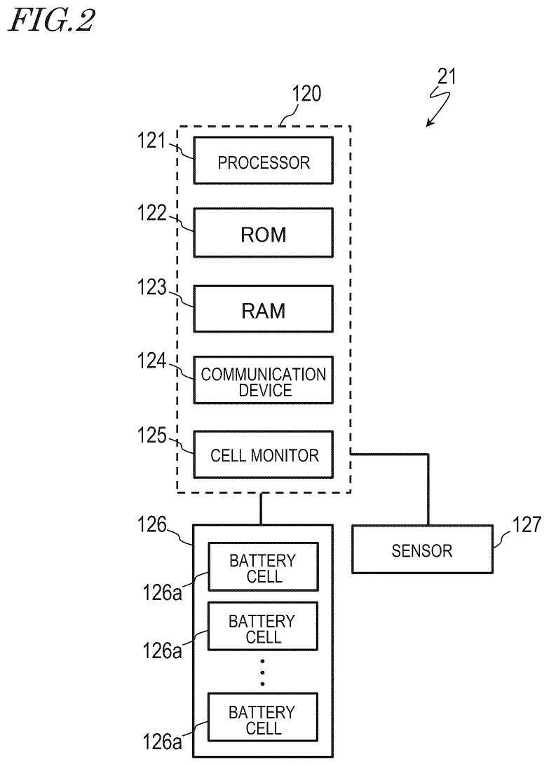

FIG. 2 is a block diagram showing an example of a hardware configuration of the battery packs 21. The battery packs 21a and 21b each include the components shown in FIG. 2.

The battery packs 21 each include the BMS 120, a battery module 126, and a sensor 127. The BMS 120 controls various operations of the battery pack 21 such as charge/discharge, and monitors a state of the battery pack 21. The BMS 120 monitors the voltage, the current, the temperature, the SOC (State of Charge), the SOH (State of Health) and the like of the battery pack 21. The BMS 120 includes a processor 121, a ROM (Read Only Memory) 122, a RAM (Random Access Memory) 123, a communication device 124 and a cell monitor 125.

The ROM 122 stores a computer program (or firmware) to cause the processor 121 to execute various processes. The computer program may be stored in the ROM 122 at the time of production of the battery pack 21. The computer program may be provided to the battery pack 21 via a storage medium or an electric communication line. Such a computer program may be marketed as commercial software.

The processor 121 may be a semiconductor integrated circuit or the like, and includes, for example, a central processing unit (CPU). The processor 121 may be a microprocessor or a microcontroller. The processor 121 consecutively executes a computer program including a group of commands to execute various processes (a computer program stored in the ROM 122) to achieve a desired process.

The processor 121 may be an FPGA (Field Programmable Gate Array), a GPU (Graphics Processing Unit), an ASIC (Application Specific Integrated Circuit) or an ASSP (Application Specific Standard Product) each including a CPU, or a combination of two or more circuits selected from these circuits.

The ROM 122 may be, for example, a writable memory (e.g., PROM), a rewritable memory (e.g., flash memory), or a memory from which data can be read but to which data cannot be written. As described above, the ROM 122 may store a computer program to cause the processor 121 to execute various processes. The ROM 122 further stores a computer program to control operations of the processor 121. The ROM 122 does not need to be a single storage medium, and may be an assembly of a plurality of storage mediums. A portion of the assembly of the plurality of storage memories may be a detachable memory.

The RAM 123 provides a work area in which the computer program stored in the ROM 122 is once developed at the time of booting. The RAM 123 does not need to be a single storage medium, and may be an assembly of a plurality of storage mediums.

The battery pack 21 may include any number of battery module(s) 126. One or more battery modules 126 are included in the battery pack 21. The battery modules 126 each include a plurality of battery cells 126a. Each of the battery modules 126 may include any number of battery cells 126a.

The sensor 127 may be a current sensor to detect the current of the battery pack 21, a voltage sensor to detect the voltage of the battery pack 21, a temperature sensor to detect the temperature of the battery pack 21, or the like. The cell monitor 125 monitors the current, the voltage, the temperature or the like of the battery pack 21 based on an output signal from the sensor 127. The cell monitor 125 outputs information representing the current, the voltage, the temperature or the like to the processor 121. The sensor 127 may detect the current, the voltage, the temperature or the like of each of the battery modules 126.

The communication device 124 is a communication module for wired communication with the drive unit 30. The communication devices 124 of the plurality of battery packs 21 may perform wired communication with each other. The communication may be performed by a communication system such as, for example, a CAN (Controller Area Network) or the like. The communication is not limited to the wired communication and may be wireless communication.

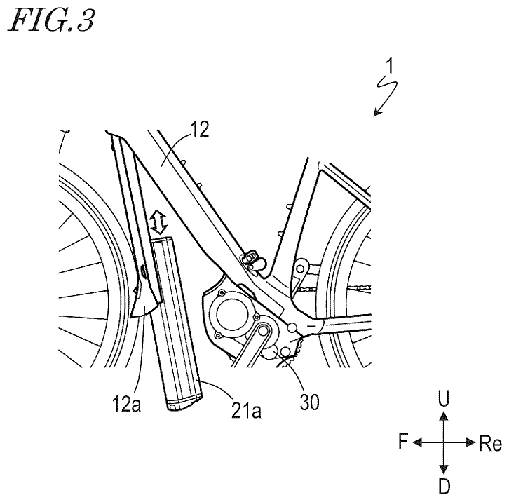

As described above, the battery packs 21 may be portable battery packs that are attachable to, and detachable from, the electrically assisted bicycle 1. FIG. 3 shows how the battery pack 21a is attached to, and detached from, the electrically assisted bicycle 1. In this example, the battery pack 21a is provided inside the down tube 12. At least a portion of the down tube 12 has a U-shaped cross-section, and the down tube 12 is provided with a cover 12a covering the U-shaped portion. The cover 12a is opened, so that the battery pack 21a may be detached from, or attached to, the down tube 12.

For the attachment and detachment of the battery pack 21a, the cover of the top tube 14 is opened, so that the battery pack 21b may be detached from, or attached to, the top tube 14.

The battery packs 21 are attachable and detachable so that the battery packs 21 may each be charged by being connected with an external charging device in a state of being detached from the electrically assisted bicycle 1. Therefore, even in a case where, for example, the charging device that charges the battery packs 21 is not provided at a parking spot, the battery packs 21 may be carried to the spot where the charging device is located and then charged. The battery packs 21 are attachable and detachable so that the number of the battery packs 21 to be mounted on the electrically assisted bicycle 1 may be adjusted.

The battery packs 21 may be charged in a state of being attached to the electrically assisted bicycle 1. In this case, for example, a connector of the charging device is connected to a connector provided in the electrically assisted bicycle 1, and thus the battery packs 21 may be charged.

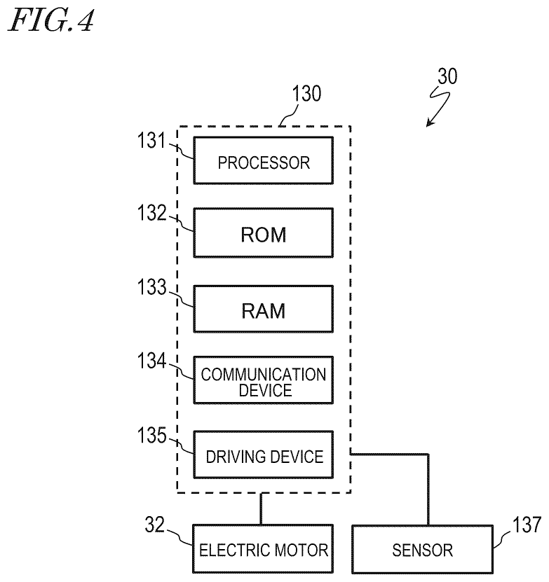

FIG. 4 is a block diagram showing an example of a hardware configuration of the drive unit 30.

The drive unit 30 includes the MCU 130, the electric motor 32, and a sensor 137. The MCU 130 includes a processor 131, a ROM 132, a RAM 133, a communication device 134, and a driving device 135. The configurations of the processor 131, the ROM 132 and the RAM 133 are substantially the same as those of the processor 121, the ROM 122 and the RAM 123 of each of the battery packs 21 and will not be described.

The ROM 132 stores a computer program (or firmware) to cause the processor 131 to execute various processes. The computer program may be stored in the ROM 132 at the time of production of the drive unit 30. The computer program may be provided to the drive unit 30 via a storage medium or an electric communication line. Such a computer program may be marketed as commercial software. The processor 131 consecutively executes a computer program including a group of commands to execute various processes (a computer program stored in the ROM 132) to achieve a desired process. The processor 131 controls operations of the drive unit 30.

The driving device 135 includes a power source circuit that outputs electric power to drive the electric motor 32. The power source circuit includes, for example, a smoothing circuit to smooth a DC voltage that is output by each of the battery packs 21, an inverter circuit to generate a motor driving current, and the like.

The sensor 137 may be a torque sensor to detect a torque generated at rotation shafts including the pedal crankshaft 35, a rotation sensor to detect the rotation of the electric motor 32, or the like. The processor 131 controls operations of the driving device 135 based on an output signal from the sensor 137.

The processor 131 controls the driving device 135 such that the electric motor 32 generates an assist power in accordance with the magnitude of the torque detected by the torque sensor. The driving device 135 generates and outputs a motor driving current to drive the electric motor 32. The electric motor 32 supplied with the motor driving current is rotated and generates the assist power. The assist power generated by the electric motor 32 is conveyed to the driving sprocket 38 (FIG. 1) via the decelerator or the like. The rotation of the driving sprocket 38 is conveyed to the rear wheel 7 via the chain 27.

The communication device 134 may be a communication module for wired communication with the battery packs 21 and the meter unit 5 (FIG. 1). The communication may be performed by a communication system such as, for example, a CAN or the like. The communication device 134 may perform wired communication with each of the battery packs 21 and/or the meter unit 5.

Now, a battery control system to control operations of the plurality of battery packs 21 will be described.

FIG. 5 is a block diagram showing a battery control system 20 according to an example embodiment. The battery control system 20 includes the plurality of battery packs 21. In the example shown in FIG. 5, the battery control system 20 includes the battery packs 21a and 21b as the battery packs 21.

The plurality of battery packs 21 each include a battery housing 110 to accommodate the BMS 120 and the battery module 126. The battery housing 110 is also referred to as the “casing”. The battery housing 110 is provided with a connector (plug) 111.

The electrically assisted bicycle 1 includes connectors (receptacles) 101 and 102 respectively connectable with the connectors 111 of the battery packs 21. The connectors 101 and 102 are provided inside, for example, the down tube 12 and the top tube 14. In the example shown in FIG. 5, the connector 111 of the battery pack 21a is connected with the connector 101, and the connector 111 of the battery pack 21b is connected with the connector 102.

The battery pack 21a may supply the electric power to drive the electric motor 32 to the MCU 130, or may communicate with the MCU 130 via the connector 111 and the connector 101. The battery pack 21b may supply the electric power to drive the electric motor 32 to the MCU 130, or may communicate information with the MCU 130 via the connector 111 and the connector 102. The battery pack 21a and the battery pack 21b may communicate information via the connectors 111, 101 and 102.

In an example embodiment, one of the plurality of battery packs 21 has authority to output the electric power to drive the electric motor 32, and the other battery pack 21 does not have the authority. The battery pack 21 having the authority supplies the electric power to drive the electric motor 32 to the MCU 130, and the battery pack 21 not having the authority waits without supplying the electric power to drive the electric motor 32 to the MCU 130.

In an example embodiment, the “battery pack having the authority to output the electric power to drive the electric motor 32” will be expressed as the “authorized battery pack”. The battery pack not having the authority to output the electric power to drive the electric motor 32″ will be expressed as the “unauthorized battery pack”.

In the initial settings made when the power of the electrically assisted bicycle 1 is turned on, which one of the battery packs 21 is the “authorized battery pack” may be determined based on, for example, the positions, in the electrically assisted bicycle 1 to which the plurality of battery packs 21 are connected, or may be determined as a result of transmission/receiving of information performed between the plurality of battery packs 21.

For example, the MCU 130 provides the battery pack 21 connected with the connector 101 and the battery pack 21 connected with the connector 102 with unique information different from each other. The BMS 120 of each battery pack 21 may determine whether the corresponding battery pack 21 is to be set as the “authorized battery pack” or the “unauthorized battery pack” based on the provided unique information. The unique information may be provided in advance to each of the plurality of battery packs 21. One of the connectors 101 and 102 may be provided with a terminal specifying that the corresponding battery pack 21 is to be the “authorized battery pack”.

Herein, as one example, the battery pack 21a connected with the connector 101 is set as the “authorized battery pack”, and the battery pack 21b connected with the connector 102 is set as the “unauthorized battery pack”.

In an example embodiment, the BMSs 120 of the plurality of battery packs 120 mutually transmit/receive information. The processor 121 of the battery pack 21a generates and outputs internal information on the state of the battery pack 21a. The BMS 120 of the battery pack 21b generates and outputs internal information on the state of the battery pack 21b.

The internal information includes at least one type of information among, for example, life information, information representing presence/absence of abnormality, information representing presence/absence of authority, information representing the upper limit of the current that can be output, information representing the battery remaining capacity, and information representing the battery capacity. The information representing the battery remaining capacity represents, for example, SOC (State of Charge), DOD (Depth of Discharge), ampere hour (Ah) or watt hour (Wh). The information representing the battery capacity represents, for example, FCC (Full Charge Capacity), SOH (State of Health) or discharge capacity (Ah, Wh). The BMS 120 may perform a computation based on, for example, the value detected by the sensor 127 and the time period counted, and generate such information. The life information is information by which it is checked whether or not the battery pack 21 is operating. The BMS 120 may output, for example, a heartbeat as the life information.

The BMSs 120 of the plurality of battery packs 21 mutually transmit/receive the internal information on the respective battery packs 21. As a result, the plurality of battery packs 21 may monitor each other regarding the states thereof.

The internal information mutually transmitted/received between the plurality of battery packs 21 may include the same type of information on the plurality of battery packs 21. With such a setting, the plurality of battery packs 21 may monitor each other regarding the states thereof with no master-slave relationship.

In an example embodiment, the authorized battery pack 21 is changed to another battery pack among the plurality of battery packs 21 based on the above-described internal information.

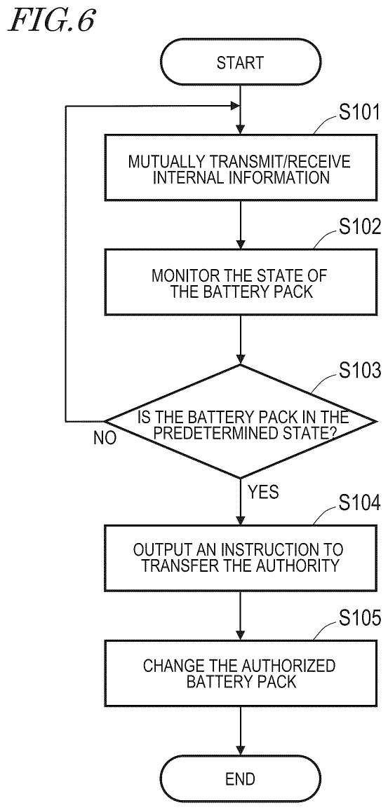

FIG. 6 is a flowchart showing an example of a process of changing the authorized battery pack 21. The BMSs 120 of the battery pack 21a and the battery pack 21b mutually transmit/receive the internal information on the respective battery packs 21 (step S101) and monitor each other regarding the states thereof (step S102). At this point, the processor 121 of the battery pack 21a also monitors the state of the battery pack 21a, and the processor 121 of the battery pack 21b also monitors the state of the battery pack 21b.

The processor 121 of the battery pack 21a as the “authorized battery pack” performs a control of outputting the electric power to drive the electric motor 32 to the MCU 130. The state of the battery pack 21a is changed during the output of the electric power to the MCU 130. For example, a decrease in the battery remaining capacity, a rise in the battery temperature or the like changes the upper limit of the current that can be output by the battery pack 21a. For example, the ROM 122 of the BMS 120 stores, in advance, table information representing the relationship among the battery remaining capacity, the battery temperature and the upper limit of the current that can be output by the battery. The processor 121 changes the upper limit of the current that can be output based on such table information.

The processor 121 of the battery pack 21a determines whether or not the battery pack 21a is in a predetermined state (step S103). The predetermined state may be, for example, at least one of a state where the upper limit of the current that can be output is lower than a threshold value, a state where the output voltage is lower than a threshold value, a state where the battery remaining capacity is smaller than a threshold value, or a state where the battery temperature is higher than or equal to a threshold value. Information on these threshold values is stored in advance in the ROM 122 of the BMS 120.

In a case it is determined that the battery pack 21a is in the predetermined state, the processor 121 of the battery pack 21a outputs, to the battery pack 21b, an instruction indicating that the authority is to be transferred to the battery pack 21b (step S104). For example, when the upper limit of the current that can be output by the battery pack 21a becomes lower than the threshold value, the processor 121 outputs the above-described instruction to the battery pack 21b. Upon receipt of the instruction, the processor 121 of the battery pack 21b updates the battery pack 21b to the “authorized battery pack” (step S105). For example, the processor 121 of the battery pack 21b updates the information representing presence/absence of authority to “authorized” and stores the updated information in the ROM 122.

The processor 121 of the battery pack 21a updates the battery pack 21a to the “unauthorized battery pack”. For example, the processor 121 of the battery pack 21a updates the information representing presence/absence of authority to “unauthorized” and stores the updated information in the ROM 122. The processor 121 of the battery pack 21a updated to the “unauthorized battery pack” stops the control of outputting the electric power to drive the electric motor 32 to the MCU 130, but continues transmitting/receiving the internal information with the processor 121 of the other battery pack 21. The internal information on the battery pack 21a may be continuously transmitted/received by use of, for example, a predischarge output.

The processor 121 of the battery pack 21b newly set as the “authorized battery pack” performs a control of outputting the electric power to drive the electric motor 32 to the MCU 130.

According to an example embodiment, in a case where the battery pack 21a is in the predetermined state (e.g., the state where the upper limit of the current that can be output is lower than the threshold value), the authority is transferred from the battery pack 21a to the battery pack 21b. In this manner, a stable supply of the electric power to the drive unit 30 may be continued.

The change in the authorized battery pack is made by transmission/receiving of information performed between the BMSs 120 of the plurality of battery packs 21. The MCU 130 of the drive unit 30 does not need to monitor the states of the plurality of battery packs 21 to perform the process of changing the authorized battery pack 21. As a result, the communication load and the computation load on the MCU 130 may be alleviated.

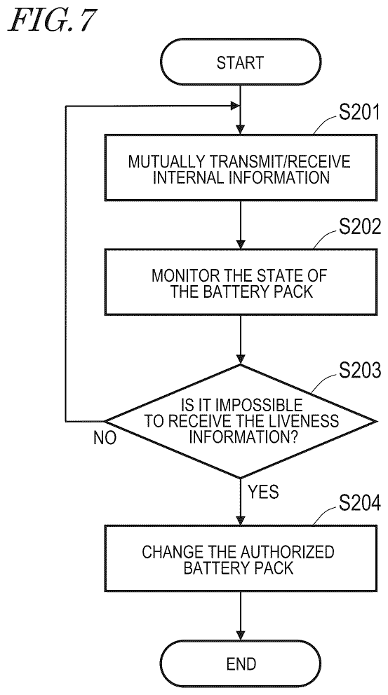

FIG. 7 is a flowchart showing another example of a process of changing the authorized battery pack 21. The authorized battery pack 21 may be changed in a case where the existence of the current authorized battery pack 21 is not confirmed due to malfunction or the like of the currently authorized battery pack 21.

The operations of steps S201 and S202 shown in FIG. 7 are the same as those of steps S101 and S102 shown in FIG. 6. The BMSs 120 of the plurality of battery packs 21 mutually transmit/receive the life information. The bidirectional communication of the life information is performed a plurality of times per second.

The processor 121 of the battery pack 21a as the “authorized battery pack” transmits the life information to the battery pack 21b. The processor 121 of the battery pack 21b determines whether or not it is impossible to receive the life information from the battery pack 21a (step S203).

In a case it is determined that it is impossible to receive the life information from the battery pack 21a, the processor 121 of the battery pack 21b updates the battery pack 21b to the “authorized battery pack” (step S204). For example, the processor 121 of the battery pack 21b updates the battery pack 21b to the “authorized battery pack” in a case where the life information from the battery pack 21a has not been received for a predetermined time period continuously. The predetermined time period is, for example, 3 seconds to 6 seconds, but is not limited thereto.

The processor 121 of the battery pack 21b newly set as the “authorized battery pack” performs a control of outputting the electric power to drive the electric motor 32 to the MCU 130.

In a case where the operation of the authorized battery pack 21a cannot be confirmed, the battery pack 21b is set as the authorized battery pack. In this manner, a stable supply of the electric power to the drive unit 30 may be continued.

The process of changing the authorized battery pack 21 is also applicable to where three or more battery packs 21 are mounted on the electrically assisted bicycle 1.

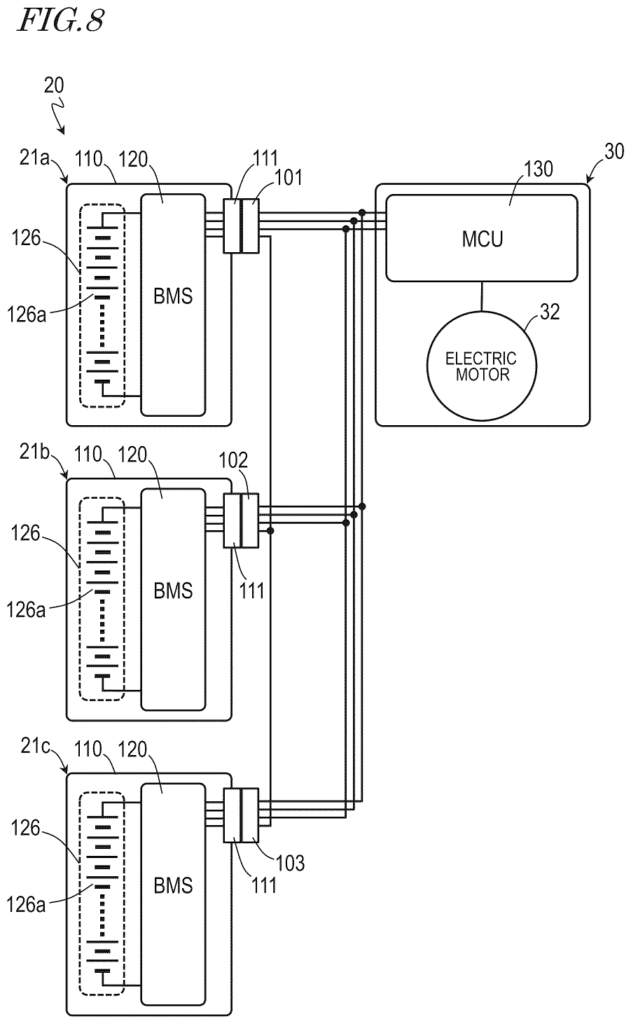

FIG. 8 is a block diagram showing another example of the battery control system 20 according to an example embodiment. In the example shown in FIG. 8, the battery control system 20 includes three battery packs 21a, 21b and 21c as the battery packs 21. The battery pack 21c has, for example, the same configuration as that of each of the battery packs 21a and 21b. The battery pack 21c may be located at any position. The battery pack 21c may be mounted on, for example, the down tube 12, the top tube 14 or the seat tube 16.

In the example shown in FIG. 8, the electrically assisted bicycle 1 includes a connector (receptacle) 103. A connector 111 of the battery pack 21c is connected with the connector 103.

The battery pack 21c may supply the electric power to drive the electric motor 32 to the MCU 130, or may communicate with the MCU 130 via the connector 111 and the connector 103. The battery packs 21a, 21b and 21c may mutually communicate information via the connectors 101, 102 and 103.

Herein, as one example, the battery pack 21a connected with the connector 101 is set as the “authorized battery pack”, and the battery packs 21b and 21c connected with the connectors 102 and 103 are set as “unauthorized battery packs”.

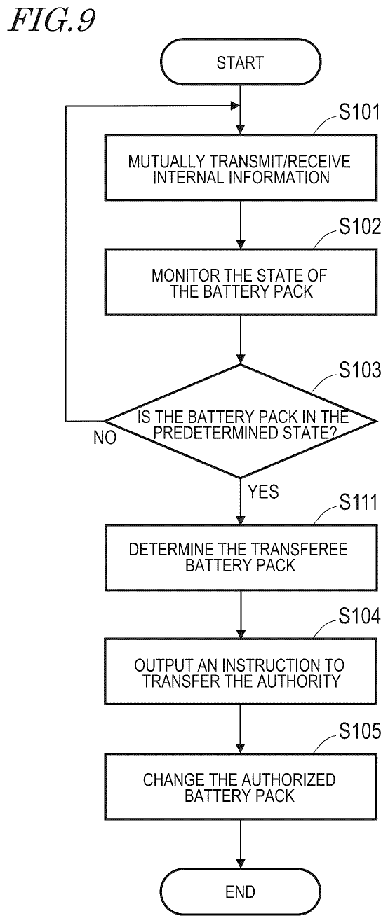

FIG. 9 is a flowchart showing still another example of a process of changing the authorized battery pack 21. The operations of steps S101 through S103 shown in FIG. 9 are the same as those of steps S101 through S103 shown in FIG. 6 except for the number of the battery packs 21. The BMSs 120 of the battery packs 21a, 21b and 21c mutually transmit/receive internal information on the respective battery packs (step S101) and monitor each other regarding the states thereof (step S102).

The processor 121 of the battery pack 21a as the “authorized battery pack” determines whether or not the battery pack 21a is in a predetermined state (step S103). The predetermined state is, for example, at least one of a state where the upper limit of the current that can be output is lower than a threshold value, a state where the output voltage is lower than a threshold value, a state where the battery remaining capacity is smaller than a threshold value, or a state where the battery temperature is higher than or equal to a threshold value.

In a case it is determined that the battery pack 21a is in the predetermined state, the processor 121 of the battery pack 21a determines a transferee battery pack, to which the authority is to be transferred, from among the unauthorized battery packs 21b and 21c (step S111). For example, when the upper limit of the current that can be output by the battery pack 21a becomes lower than the threshold value, the processor 121 determines the transferee battery pack.

The processor 121 of the battery pack 21a determines the transferee battery pack, from among the battery packs 21b and 21c, based on the internal information on each of the battery packs 21b and 21c. For example, the processor 121 of the battery pack 21a determines, as the transferee battery pack, a battery pack having the largest battery remaining capacity among the battery packs 21b and 21c. Alternatively, for example, the processor 121 of the battery pack 21a determines, as the transferee battery pack, a battery pack having the highest upper limit of the current that can be output among the battery packs 21b and 21c. In this manner, the authority may be transferred to the battery pack that can supply the electric motor 32 with larger electric power.

Alternatively, for example, the processor 121 of the battery pack 21a may determine the transferee battery pack, from among the battery packs 21b and 21c, based on the unique information assigned to each of the battery packs 21b and 21c. For example, each of the connectors 101, 102 and 103 (FIG. 8) may be provided with a terminal specifying the content of the internal information (e.g., number). In this case, for example, a battery pack assigned with the unique information specifying the smallest number from among the battery packs 21b and 21c, is determined as the transferee battery pack. In this manner, the transferee battery pack may be determined by a simple process.

Herein, as one example, the battery pack 21b is determined as the transferee battery pack. The processor 121 of the battery pack 21a outputs, to the battery pack 21b, an instruction indicating that the authority is to be transferred to the battery pack 21b (step S104). Upon receipt of the instruction, the processor 121 of the battery pack 21b updates the battery pack 21b to the “authorized battery pack” (step S105). The processor 121 of the battery pack 21a updates the battery pack 21a to the “unauthorized battery pack”.

The processor 121 of the battery pack 21b newly set as the “authorized battery pack” performs a control of outputting the electric power to drive the electric motor 32 to the MCU 130.

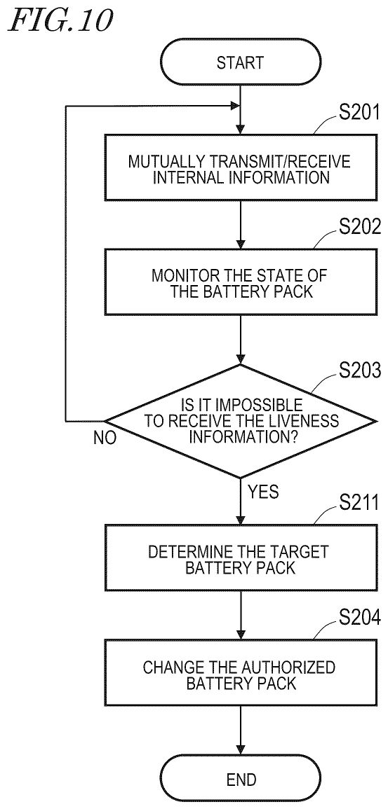

FIG. 10 is a flowchart showing still another example of a process of changing the authorized battery pack 21.

The operations of steps S201 through S203 shown in FIG. 10 are the same as those of steps S201 through S203 shown in FIG. 7 except for the number of the battery packs 21. The BMSs 120 of the plurality of battery packs 21 mutually transmit/receive the life information.

The processor 121 of the battery pack 21a as the “authorized battery pack” transmits the life information to the battery packs 21b and 21c. The processors 121 of the battery packs 21b and 21c each determine whether or not it is impossible to receive the life information from the battery pack 21a (step S203).

In a case it is determined that it is impossible to receive the life information from the battery pack 21a, the processors 121 of the battery packs 21b and 21c determine a target battery pack to which the authority is to be given from among the battery packs 21b and 21c (step S211). The processors 121 of the battery packs 21b and 21c determine the target battery pack to which the authority is to be given, from among the battery packs 21b and 21c, based on the internal information on each of the battery packs 21b and 21c. For example, the processors 121 of the battery packs 21b and 21c determine, as the target battery pack to which the authority is to be given, a battery pack having the largest battery remaining capacity among the battery packs 21b and 21c. Alternatively, for example, the processors 121 of the battery packs 21b and 21c determine, as the target battery pack to which the authority is to be given, a battery pack having the highest upper limit of the current that can be output from among the battery packs 21b and 21c. Still alternatively, for example, the processors 121 of the battery packs 21b and 21c may determine the target battery pack to which the authority is to be given, from among the battery packs 21b and 21c, based on the unique information assigned to each of the battery packs 21b and 21c.

Herein, as one example, the battery pack 21c is determined as the target battery pack to which the authority is to be given. In this case, the processor 121 of the battery pack 21c updates the battery pack 21c to the “authorized battery pack” (step S204). The processor 121 of the battery pack 21b maintains the state where the battery pack 21b is an “unauthorized battery pack”.

The processor 121 of the battery pack 21c newly set as the “authorized battery pack” performs a control of outputting the electric power to drive the electric motor 32 to the MCU 130.

In the above-described example embodiments, the processors 121 of the battery packs 21b and 21c determine the target battery pack to which the authority is to be given. Alternatively, the processor 121 of one of the battery packs 21b and 21c may determine the target battery pack to which the authority is to be given.

In the above-described example embodiments, the authorized battery pack 21 supplies the electric power to drive the electric motor 32 to the MCU 130. The present invention is not limited to this. The authorized battery pack 21 may perform a control such that an unauthorized battery pack 21 supplies the electric power to the MCU 130.

The process of changing the authorized battery pack 21 based on the life information described above with reference to FIG. 7 and FIG. 10 is also applicable to charging of the plurality of battery packs 21. In this case, the authorized battery pack 21 controls the charging of the plurality of battery packs 21. As shown in FIG. 7 and FIG. 10, in a case where it is impossible to receive the life information on the authorized battery pack 21, the authorized battery pack is changed to another battery pack 21. In this manner, the control on the charging may be performed on a normal battery pack 21.

In the above-described example embodiments, the driving wheel to which the power of a human body generated by the user stepping on the pedals and the assist power generated by the electric motor are conveyed is the rear wheel. The present invention is not limited to this. The power of the human body and the assist power may be conveyed to the front wheel, or may be conveyed to both of the front wheel and the rear wheel, in accordance with the type of the electrically assisted bicycle. The present invention may be applied to an electrically assisted bicycle including a hub motor provided on the front wheel.

Illustrative example embodiments of the present invention have been described above. This specification discloses battery control systems, battery packs, electric vehicles, battery control methods, and non-transitory computer readable media including computer programs as described below.

According to an example embodiment of the present invention, a battery control system 20 for an electric vehicle 1 includes a plurality of battery packs 21 each including a battery module 126 including a plurality of battery cells 126a, a controller 120 configured or programmed to control discharge of the battery module 126 and output internal information on a state of the battery pack 21 including the controller 120 therein, and a battery housing 110 to accommodate the battery module 126 and the controller 120, the plurality of battery packs 21 include an authorized battery pack 21 having authority to output electric power to drive an electric motor 32 generating drive power for the electric vehicle 1, and an unauthorized battery pack 21 not having the authority, a plurality of the controllers 120 of the plurality of battery packs 21 are configured or programmed to mutually transmit/receive the internal information, and at least one of the plurality of controllers 120 is configured or programmed to change the authorized battery pack 21 to another battery pack among the plurality of battery packs 21 based on the internal information.

According to an example embodiment of the present invention, the internal information is mutually transmitted/received between the plurality of battery packs 21, and the authorized battery pack 21 is changed to another battery pack based on the internal information. A vehicle controller 130 for the vehicle does not need to monitor the states of the plurality of battery packs 21 to perform the process of changing the authorized battery pack 21. As a result, the communication load and the computation load on the vehicle controller 130 may be alleviated.

In the battery control system 20 above, the internal information includes at least one of life information by which it is checked whether or not the battery pack 21 is operating, information representing presence/absence of abnormality, information representing presence/absence of the authority, information representing an upper limit of a current that can be output, information representing a battery remaining capacity, or information representing a battery capacity.

With this configuration, the plurality of battery packs 21 may monitor each other regarding the states thereof.

In the battery control system 20 above, the plurality of battery packs 21 include a first battery pack 21a as the authorized battery pack, and a second battery pack 21b as the unauthorized battery pack, in a case it is determined that the first battery pack 21a is in a predetermined state, the controller 120 of the first battery pack 21a is configured or programmed to output, to the second battery pack 21b, an instruction indicating that the authority is to be transferred to the second battery pack 21b, and the controller 120 of the second battery pack 21b is configured or programmed to set the second battery pack 21b as the authorized battery pack.

In a case where the first battery pack 21a is in the predetermined state (e.g., the state where the upper limit of the current that can be output is lower than the threshold value), the authority is transferred from the first battery pack 21a to the second battery pack 21b. In this manner, a stable supply of the electric power to the vehicle may be continued. In the battery control system 20 above, the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

In a case where the first battery pack 21a is in the above-described state, the authority is transferred from the first battery pack 21a to the second battery pack 21b. In this manner, a stable supply of the electric power to the vehicle may be continued.

In the battery control system 20 above, the plurality of battery packs 21 include an authorized battery pack 21a and two or more of the unauthorized battery packs 21b and 21c, the controller 120 of the authorized battery pack 21a, in a case it is determined that the authorized battery pack 21a is in a predetermined state, is configured or programmed to determine a transferee battery pack 21 to which the authority is to be transferred from among the two or more unauthorized battery packs 21b and 21c, and output, to the transferee battery pack 21, an instruction indicating that the authority is to be transferred to the transferee battery pack 21, and the controller 120 of the transferee battery pack 21 is configured or programmed to set the transferee battery pack 21 as the authorized battery pack.

In a case where the authorized battery pack 21a is in the predetermined state (e.g., the state where the upper limit of the current that can be output is lower than the threshold value), the authority is transferred to another battery pack 21. In this manner, a stable supply of the electric power to the vehicle may be continued.

In the battery control system 20 above, the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

In a case where the authorized battery pack 21a is in the above-described state, the authority is transferred to another battery pack 21. In this manner, a stable supply of the electric power to the vehicle may be continued.

In the battery control system 20 above, the controller 120 of the authorized battery pack 21a, before the authority is transferred, is configured or programmed to determine the transferee battery pack from among the two or more unauthorized battery packs 21b and 21c based on the internal information on each of the two or more unauthorized battery packs 21b and 21c.

With this configuration, the authority may be transferred to an appropriate battery pack 21.

In the battery control system 20 above, the controller 120 of the authorized battery pack 21a, before the authority is transferred, is configured or programmed to determine, as the transferee battery pack, a battery pack having the largest battery remaining capacity or the highest upper limit of the current that can be output from among the two or more unauthorized battery packs 21b and 21c.

With this configuration, the authority may be transferred to the battery pack 21 that can supply the electric motor 32 with larger electric power.

In the battery control system 20 above, the controller 120 of the authorized battery pack 21a, before the authority is transferred, is configured or programmed to determine the transferee battery pack from among the two or more unauthorized battery packs 21b and 21c based on unique information assigned to each of the two or more unauthorized battery packs 21b and 21c.

With this configuration, the transferee battery pack 21 may be determined by a simple process.

In the battery control system 20 above, the internal information includes the life information, the plurality of battery packs 21 include a first battery pack 21a as the authorized battery pack and a second battery pack 21b as the unauthorized battery pack, and in a case where it is impossible to receive the life information from the first battery pack 21a, the controller 120 of the second battery pack 21b is configured or programmed to set the second battery pack 21b as the authorized battery pack.

In a case where the authorized first battery pack 21a is not operating, the second battery pack 21b is set as the authorized battery pack. In this manner, a stable supply of the electric power to the vehicle may be continued.

In the battery control system 20 above, the internal information includes the life information, the plurality of battery packs 21 include the authorized battery pack 21a and two or more of the unauthorized battery packs 21b and 21c, at least one of the controllers 120 of the two or more unauthorized battery packs 21b and 21c, in a case where it is impossible to receive the life information from the authorized battery pack 21a, is configured or programmed to determine a target battery pack to which the authority is to be given from among the two or more unauthorized battery packs 21b and 21c, and the controller 120 of the target battery pack is configured or programmed to set the target battery pack as the authorized battery pack.

In a case where the authorized first battery pack 21a is not operating, another battery pack 21b or 21c is set as the authorized battery pack. In this manner, a stable supply of the electric power to the vehicle may be continued.

In the battery control system 20 above, at least one of the controllers 120 of the two or more unauthorized battery packs 21b and 21c is configured or programmed to determine the target battery pack, from among the two or more unauthorized battery packs 21b and 21c, based on the internal information on each of the two or more unauthorized battery packs 21b and 21c.

With this configuration, the authority may be transferred to an appropriate battery pack 21.

In the battery control system 20 above, at least one of the controllers 120 of the two or more unauthorized battery packs 21b and 21c is configured or programmed to determine, as the target battery pack, a battery pack having the largest battery remaining capacity or the highest upper limit of the current that can be output from among the two or more unauthorized battery packs 21b and 21c.

With this configuration, the authority may be transferred to the battery pack 21 that can supply the electric motor 32 with larger electric power.

In the battery control system 20 above, at least one of the controllers 120 of the two or more unauthorized battery packs 21b and 21c is configured or programmed to determine the target battery pack, from among the two or more unauthorized battery packs 21b and 21c, based on unique information assigned to each of the two or more unauthorized battery packs 21b and 21c.

With this configuration, the target battery pack 21 to which the authority is to be given may be determined by a simple process.

In the battery control system 20 above, the internal information mutually transmitted/received between the plurality of battery packs 21 includes a same type of information on the plurality of battery packs 21.

With this configuration, the plurality of battery packs 21 may monitor each other regarding the states thereof with no master-slave relationship.

In the battery control system 20 above, the plurality of battery packs 21 are attachable to, and detachable from, the electric vehicle 1.

With this configuration, the battery packs 21 may each be charged in a state of being detached from the vehicle. In addition, the number of the battery packs 21 to be mounted on the vehicle may be adjusted.

According to an example embodiment of the present invention, an electric vehicle 1 may include the battery control system 20 described above.

With this configuration, the electric vehicle 1, in which the communication load and the computation load on the vehicle controller 130 is decreased, may be achieved.

In the electric vehicle 1 above, the electric vehicle 1 may be an electrically assisted bicycle.

With this configuration, the electrically assisted bicycle, in which the communication load and the computation load on the vehicle controller (MCU) 130, is decreased may be achieved.

According to an example embodiment of the present invention, a battery control method for controlling a plurality of battery packs 21 for an electric vehicle 1 is executed by a plurality of computers, the plurality of battery packs 21 including an authorized battery pack 21 authorized to output electric power to drive an electric motor 32 that generates drive power for the electric vehicle 1, and an unauthorized battery pack 21 not having the authority, the plurality of battery packs 21 each configured to output internal information on a state of the corresponding battery pack 21, the battery control method including mutually transmitting/receiving the internal information between the plurality of battery packs 21, and changing the authorized battery pack 21 to another battery pack among the plurality of battery packs 21 based on the internal information mutually transmitted/received between the plurality of battery packs 21.

According to an example embodiment of the present invention, the internal information is mutually transmitted/received between the plurality of battery packs 21, and the authorized battery pack 21 is changed to another battery pack based on the internal information. A vehicle controller 130 for the vehicle does not need to monitor the states of the plurality of battery packs 21 to perform the process of changing the authorized battery pack 21. As a result, the communication load and the computation load on the vehicle controller 130 may be alleviated.

According to an example embodiment of the present invention, a non-transitory computer readable medium includes a computer program to cause a plurality of computers to execute a process of controlling a plurality of battery packs 21 for an electric vehicle 1, the plurality of battery packs 21 including an authorized battery pack 21 authorized to output electric power to drive an electric motor 32 that generates drive power for the electric vehicle 1, and an unauthorized battery pack 21 not having the authority, the plurality of battery packs 21 each configured to output internal information on a state of the corresponding battery pack 21, the computer program causing the plurality of computers to mutually transmit/receive the internal information between the plurality of battery packs 21, and change the authorized battery pack 21 to another battery pack among the plurality of battery packs 21 based on the internal information mutually transmitted/received between the plurality of battery packs 21.

According to an example embodiment of the present invention, the internal information is mutually transmitted/received between the plurality of battery packs 21, and the authorized battery pack 21 is changed to another battery pack based on the internal information. A vehicle controller 130 for the vehicle does not need to monitor the states of the plurality of battery packs 21 to perform the process of changing the authorized battery pack 21. As a result, the communication load and the computation load on the vehicle controller 130 may be alleviated.

According to an example embodiment of the present invention, a battery pack 21 for an electric vehicle includes a battery module 126 including a plurality of battery cells 126a, a controller 120 configured or programmed to control discharge of the battery module 126 and a battery housing 110 to accommodate the battery module 126 and the controller 120, wherein the electric vehicle 1 includes a plurality of battery packs 21 mounted thereon, the plurality of battery packs 21 each configured to output internal information on a state of the corresponding battery pack 21, the plurality of battery packs 21 include an authorized battery pack 21 having authority to output electric power to drive an electric motor 32 that generates drive power for the electric vehicle 1, and an unauthorized battery pack 21 not having the authority, the plurality of battery packs 21 mutually transmit/receive the internal information, and the controller 120 is configured or programmed to change the authorized battery pack 21 to another battery pack among the plurality of battery packs 21 based on the internal information mutually transmitted/received between the plurality of battery packs 21.

According to an example embodiment of the present invention, the internal information is mutually transmitted/received between the plurality of battery packs 21, and the authorized battery pack 21 is changed to another battery pack based on the internal information. A vehicle controller 130 for the vehicle does not need to monitor the states of the plurality of battery packs 21 to perform the process of changing the authorized battery pack 21. As a result, the communication load and the computation load on the vehicle controller 130 may be alleviated.

Example embodiments of the present invention are particularly useful in the field of electric vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A battery control system for an electric vehicle, the battery control system comprising:
a plurality of battery packs each including:
a battery module including a plurality of battery cells;
a controller configured or programmed to control discharge of the battery module and output internal information on a state of the battery pack including the controller therein; and
a battery housing to accommodate the battery module and the controller; wherein
the plurality of battery packs include an authorized battery pack having authority to output electric power to drive an electric motor that generates drive power for the electric vehicle, and an unauthorized battery pack not having the authority;
the controllers of the plurality of battery packs are configured or programmed to mutually transmit/receive the internal information; and
at least one of the controllers is configured or programmed to change the authorized battery pack to another battery pack among the plurality of battery packs based on the internal information.

2. The battery control system of claim 1, wherein the internal information includes at least one of life information by which it is checked whether or not the battery pack is operating, information representing presence/absence of abnormality, information representing presence/absence of the authority, information representing an upper limit of a current that can be output, information representing a battery remaining capacity, or information representing a battery capacity.

3. The battery control system of claim 1, wherein
the plurality of battery packs include a first battery pack as the authorized battery pack, and a second battery pack as the unauthorized battery pack;
in a case it is determined that the first battery pack is in a predetermined state, the controller of the first battery pack is configured or programmed to output, to the second battery pack, an instruction indicating that the authority is to be transferred to the second battery pack; and
the controller of the second battery pack is configured or programmed to set the second battery pack as the authorized battery pack.

4. The battery control system of claim 3, wherein the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

5. The battery control system of claim 1, wherein
the plurality of battery packs include an authorized battery pack and two or more of the unauthorized battery packs;
the controller of the authorized battery pack, in a case it is determined that the authorized battery pack is in a predetermined state, is configured or programmed to:
determine a transferee battery pack to which the authority is to be transferred from among the two or more unauthorized battery packs; and
output, to the transferee battery pack, an instruction indicating that the authority is to be transferred to the transferee battery pack; and
the controller of the transferee battery pack is configured or programmed to set the transferee battery pack as the authorized battery pack.

6. The battery control system of claim 5, wherein the predetermined state includes at least one of a state where an upper limit of a current that can be output is lower than a threshold value, a state where an output voltage is lower than a threshold value, a state where a battery remaining capacity is smaller than a threshold value, or a state where a temperature is higher than or equal to a threshold value.

7. The battery control system of claim 5, wherein the controller of the authorized battery pack, before the authority is transferred, is configured or programmed to determine the transferee battery pack from among the two or more unauthorized battery packs based on the internal information on each of the two or more unauthorized battery packs.

8. The battery control system of claim 7, wherein the controller of the authorized battery pack, before the authority is transferred, is configured or programmed to determine, as the transferee battery pack, a battery pack having the largest battery remaining capacity or the highest upper limit of the current that can be output from among the two or more unauthorized battery packs.

9. The battery control system of claim 5, wherein the controller of the authorized battery pack, before the authority is transferred, is configured or programmed to determine the transferee battery pack from among the two or more unauthorized battery packs based on unique information assigned to each of the two or more unauthorized battery packs.

10. The battery control system of claim 2, wherein
the internal information includes the life information;
the plurality of battery packs include a first battery pack as the authorized battery pack and a second battery pack as the unauthorized battery pack; and
in a case where it is impossible to receive the life information from the first battery pack, the controller of the second battery pack is configured or programmed to set the second battery pack as the authorized battery pack.

11. The battery control system of claim 2, wherein
the internal information includes the life information;
the plurality of battery packs include the authorized battery pack and two or more of the unauthorized battery packs;
at least one of the controllers of the two or more unauthorized battery packs, in a case where it is impossible to receive the life information from the authorized battery pack, is configured or programmed to determine a target battery pack to which the authority is to be given from among the two or more unauthorized battery packs; and
the controller of the target battery pack is configured or programmed to set the target battery pack as the authorized battery pack.

12. The battery control system of claim 11, wherein at least one of the controllers of the two or more unauthorized battery packs is configured or programmed to determine the target battery pack, from among the two or more unauthorized battery packs, based on the internal information on each of the two or more unauthorized battery packs.

13. The battery control system of claim 12, wherein at least one of the controllers of the two or more unauthorized battery packs is configured or programmed to determine, as the target battery pack, a battery pack having the largest battery remaining capacity or the highest upper limit of the current that can be output from among the two or more unauthorized battery packs.

14. The battery control system of claim 11, wherein at least one of the controllers of the two or more unauthorized battery packs is configured or programmed to determine the target battery pack, from among the two or more unauthorized battery packs, based on unique information assigned to each of the two or more unauthorized battery packs.

15. The battery control system of claim 1, wherein the internal information mutually transmitted/received between the plurality of battery packs includes a same type of information on the plurality of battery packs.

16. The battery control system of claim 1, wherein the plurality of battery packs are attachable to, and detachable from, the electric vehicle.

17. An electric vehicle comprising:
the battery control system of claim 1.

18. The electric vehicle of claim 17, wherein the electric vehicle is an electrically assisted bicycle.

19. A battery control method for controlling a plurality of battery packs for an electric vehicle, the method being executed by a plurality of computers, the plurality of battery packs including an authorized battery pack authorized to output electric power to drive an electric motor that generates drive power for the electric vehicle and an unauthorized battery pack not having the authority, the plurality of battery packs each configured to output internal information on a state of the corresponding battery pack, the battery control method comprising:
mutually transmitting/receiving the internal information between the plurality of battery packs; and
changing the authorized battery pack to another battery pack among the plurality of battery packs based on the internal information mutually transmitted/received between the plurality of battery packs.

20. A battery pack for an electric vehicle, the battery pack comprising:
a battery module including a plurality of battery cells;
a controller configured or programmed to control discharge of the battery module; and
a battery housing to accommodate the battery module and the controller; wherein
the electric vehicle includes a plurality of battery packs, including the battery pack, mounted thereon;
the plurality of battery packs are each configured to output internal information on a state of the corresponding battery pack;
the plurality of battery packs include an authorized battery pack having authority to output electric power to drive an electric motor that generates drive power for the electric vehicle, and an unauthorized battery pack not having the authority;
the plurality of battery packs are configured to mutually transmit/receive the internal information; and
the controller is configured or programmed to change the authorized battery pack to another battery pack among the plurality of battery packs based on the internal information mutually transmitted/received between the plurality of battery packs.
